(19) United States
(12) Patent Application Publication
(10) Pub. No.: US 2014/0030043 A1
(43) Pub. Date: Jan. 30, 2014

(54) SYSTEM AND PROCESS FOR AUTOMATED HIGH-EFFICIENCY BOOK PRODUCTION

(71) Applicants: Steve Brown, Medford, OR (US); Corey Christiansen, Medford, OR (US); Grant Moulton, Medford, OR (US)

(72) Inventors: Steve Brown, Medford, OR (US); Corey Christiansen, Medford, OR (US); Grant Moulton, Medford, OR (US)

(73) Assignee: Consolidated Graphics, Inc., Houston, TX (US)

(21) Appl. No.: 13/561,890

(22) Filed: Jul. 30, 2012

(51) Int. Cl. B42C 19/00; B42C 9/00; B42C 7/00; B42C 11/04

(52) U.S. Cl. 412/3; 412/5; 412/13; 412/11

(57) ABSTRACT

An automated book production system includes a binding machine, digital web press, laminating/UV coating machine, casing machine, and a completion machine. Through utilization of a batching process, barcode tracking, and a streamlined production layout, book production is increased.

### FIELD OF THE INVENTION

The present invention relates generally to book binding and, more specifically, to a high-efficiency automated manufacturing system and process for hard cover books.

### BACKGROUND

As will be described below, conventional book binding processes utilized a series manual steps. However, such manual steps result in increased error rates, labor costs, and production line inefficiencies. Moreover, such traditional processes do not lend themselves to the high-volume demand associated with printing and binding orders submitted over the Internet.

In conventional binding processes, sheafs of printed materials, each sheaf representing an order, are stacked for binding. Each sheaf is provided with a barcode, stacked with other sheafs on a cart, and pushed to a preparation station. An operator, working from the top to bottom of the stack, and referring to the banner sheet (data sheets printed on top of the first page of every order specific to that order), isolates and processes each order, one at a time. The order may contain one or multiple texts. The operator disposes of the protective sheets (usually identified by a particular color), which are used to separate individual texts (sets of pages that make up a single book), into a recycling bin. The operator then places a static front end sheet on top of each text stack (stack of individual texts), places either a logo or no-logo end sheet beneath the text depending on the order specifications found on the banner sheet, and puts the text with the end sheets onto another stack. Lastly, the operator replaces the banner sheet on the top of each individual order.

After the operator correctly positions all the end sheets for all orders in a batch, the operator pushes the cart to the binding machine. A batch is a collection of orders that are filtered by ship time, product type, page numbers, and design specifications. Similar products are batched together and move through production. Each batch is assigned a batch sheet, which is a sheet of paper that is printed on top of the orders. Each batch sheet includes a barcode ID number called the Batch ID, and each order has an order number barcode that is printed on the batch sheet as well. Every order in the batch is listed on the batch sheet. The batch sheet provides production with each order's order number barcode, line ID barcode, ship date, product type, and batch barcode ID.

The binding machine is a manually operated, and very time consuming, machine used to secure text pages into a text block. At the binding machine, the operator refers to the batch manifest (provides information related to the batch, which may include the batch number, number of orders in the batch, page count for each order, etc.) to load the corresponding preset program and the correct crash paper (individual sheets based on L, XL) into the machine.

However, the operator must manually gauge the transport carriage to the correct page count of the text. Every variation of approximately eight pages must be gauged to a different setting. Spine sizes are gauged by hand, as the operator takes each bound text and places it into the gauging unit. The gauging unit is a box with an adjustable arm that determines the gauge to which the machine needs to be set. When the arm is extended, completely closed, the gauge is zero. When the operator closes the arm, pressure is applied along the spine of the book. The machine uses this gauge to adjust all elements of the binder to the transport carriages. The carriage has stationary hands in the back and an adjustable hand in the front. Based on the gauge, the adjustable hand moves in and out to allow for placement of the text in the carriage. When the text is dropped into the carriage, the hand closes and holds the bound text in place.

A nipping plate is the section of the binding machine which holds the crash paper and conforms it to the spine. It comprised of a solid plate that had two adjustable arms that auto adjust to the width of the spine of each book based on the gauge. After the machine is manually gauged, the operator inserts one set of text and end sheets at a time into the carriages, leaving the banner sheets on the cart in the same order in which the texts are fed into the machine.

As the text drops into the carriage, the text is moved over a milling blade to trim the spine. The spine then passes through glue rollers, one in front and one behind the end sheets. The glue rollers apply a small strip of glue on the bottom of the end sheet right above the spine. Thereafter, the entire length of the spine and the carriage come to rest over the nipping plate.

The entire plate continues to move up to the carriage. In so doing, the plate pushes the crash paper onto the freshly glued spine of the book, and forms the crash paper around the spine of the book. The carriage remains stationary until the operator manually drops the next text into the binder or pushes a bypass button to move the carriages along their track in the binder. Once the bind is secure, the carriage opens, the text drops to the out feed, and the conveyor cycles the text out.

After the entire batch has been bound, it is taken to the Rip/Tear station to be prepared for further processing. The operator manually takes one text block at a time, and tears off the excess crash paper at the perforation on either side of the end sheets, leaving enough paper to cover the side glue and hold the text block together. Once the operator removes the flaps from the front and back of the book, he opens the book to remove the wax paper covering (easily removable coated paper) on the bottom of the end sheet that covered a thin adhesive strip. When the wax paper is manually removed, the operator immediately closes the book and presses down on the end sheet, thus allowing the adhesive to stick on the first page of the book. Moreover, the same action must be performed between the last page and the back end sheet of the text block.

After the operator completes removal of the flaps and wax paper, he takes the stack of banner sheets and matches each to the books by manually referencing the order number printed on the text to the order number on the banner sheet, taking into account multiple quantity orders. After the entire batch is complete, it is placed on a cart and moved it to the ink jetting station. The ink jetting station applies a barcode to the outside of the end sheet on the front of the book.

Each book is fed into the ink jetter and placed on a conveyor belt. As it moves along, a barcode reader scans the barcode, and the ink jet printer sprays a copy of the barcode to the outside of the book. At the end of the conveyor, the books are dropped into a bin where they wait for the operator to finish running the batch. Once the batch was completed, the operator takes the stack of text blocks and rematches the banner sheets to the books. The text blocks and their banner sheets are then put back onto the cart and rolled to the three-knife trimmer for cutting. The operator manually loads the text blocks into trimmer one at a time. Once the operator finishes the batch, he restacks the books on to the cart with their corresponding banner sheets, and moves them to the stitcher.

The stitcher is then manually adjusted according to the spine length of the text blocks, either L or XL, correlating the length of each stitch to the width of the spine. This ensures the stitches are not too short to reach through the entire thickness of the book, nor too long that there was excess wire. Each text block is placed on the stitcher platform and aligned with the stitcher heads. The operator then steps on a pedal to make the stitcher drive staples into the spine end of the text block. After the text block is stitched, the operator places the stitched end into the smasher. When the text block is in place, the operator steps on a pedal again to drop a weight applying 12,000 pounds of pressure down on the stitched end.

From there, wraps and jackets are printed and coated with laminate and UV coating as required, and barcodes are applied. In this manual conventional process, however, the machine processes each wrap one at a time by applying glue to a chipboard and securing the photo wrap to it. From there it goes on to spine break to headband applications. The spine break involves creasing the wrap on either side of the spine of chipboard in order to give the hard cover case the preliminary shape of the spine. To do so, the operator straddles the case over a vertical metal frame and presses on the case, thus bending the wrap in the gap between the spine and either cover. When all the cases are created, the operator applies headbands to the spine. Headbands are precut ornamental squares of fabric that adhere inside the head and foot of the spine. The operator manually applies it onto the spine near either end, not exceeding the edge of the case. The operator then replaces the cases onto the cart for further processing.

The cover is then bound to the text. The binding machine processes one book at a time, and is equipped with scanners that scan the barcode to verify that the text block is accurately married to the cover with an identical barcode. Once verified, the text block and covered are married and the book is transported to the smasher. All books in that batch are smashed, returned to the cart with all other books in that order and then moved to the quality control area for the final inspection before shipping.

Given the numerous and tedious manual steps in the foregoing conventional binding process, only roughly 2400 books could be produced in a 12 hour period. However, as will be described herein, production is greatly increased through use of the features of the present invention, which more than doubles the conventional production in a single hour.

Accordingly, in view of the foregoing disadvantages associated with conventional manual book binding processes, there is a need in the art for an improved high-efficiency book binding process which eliminates waste, decreases manual labor costs, streamlines production, and increases the volume of production capability.

### SUMMARY OF THE INVENTION

Exemplary embodiments of the present invention provide systems and related processes for automated, high-efficiency book binding. An exemplary system comprises a binding machine and a completion machine. The binding machine includes a mechanism adapted to receive end sheets and a text, the text being made of a plurality of pages; a mechanism adapted to apply an end sheet on a front and back of the text, thereby resulting in a front end sheet and a back end sheet; a mechanism adapted to convey the text into a crash paper applicator, wherein crash paper is applied to a spine of the text and a portion of the front and back end sheets, thus creating a text block; a mechanism adapted to convey the text block to a barcode reader, wherein a barcode of the text block is read and, thereafter, printed on the text block; and a trimmer adapted to trim the text block, wherein the text and text block are conveyed through the binding machine without the need to remove the text or text block from the binding machine. The completion machine is adapted to insert the text block into a casing, thereby forming a book.

The present invention also utilizes a batching process in which individual orders are grouped together based upon similar product types, spine size, ship date, and reprint history, which allow the groups to move through production together. Barcodes are strategically printed on all book components to facilitate tracking throughout the production process. In addition, a press having a slitter is utilized to print and cut wraps and jackets at a single station, thereby increasing the overall efficiency of the binding process.

### BRIEF DESCRIPTION OF THE DRAWINGS

FIG. 1 is a aerial diagrammatical illustration of a floor plan layout for an automated book production facility according to an exemplary embodiment of the present invention;

FIG. 2 is an exploded view of binding station 2 of FIG. 1;

FIG. 3 is an exploded view of casing section 8 of FIG. 1;

FIG. 4 is an exploded view of completion section 9 of FIG. 1; and

FIG. 5 is a process flow chart for a automated manufacturing process according to an exemplary methodology of the present invention.

### DESCRIPTION OF ILLUSTRATIVE EMBODIMENTS

Illustrative embodiments and related methodologies of the present invention are described below as they might be employed in a high efficiency book binding process. In the interest of clarity, not all features of an actual implementation are described in this specification. It will of course be appreciated that in the development of any such actual embodiment or methodology, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the invention will become apparent from consideration of the following description and drawings.

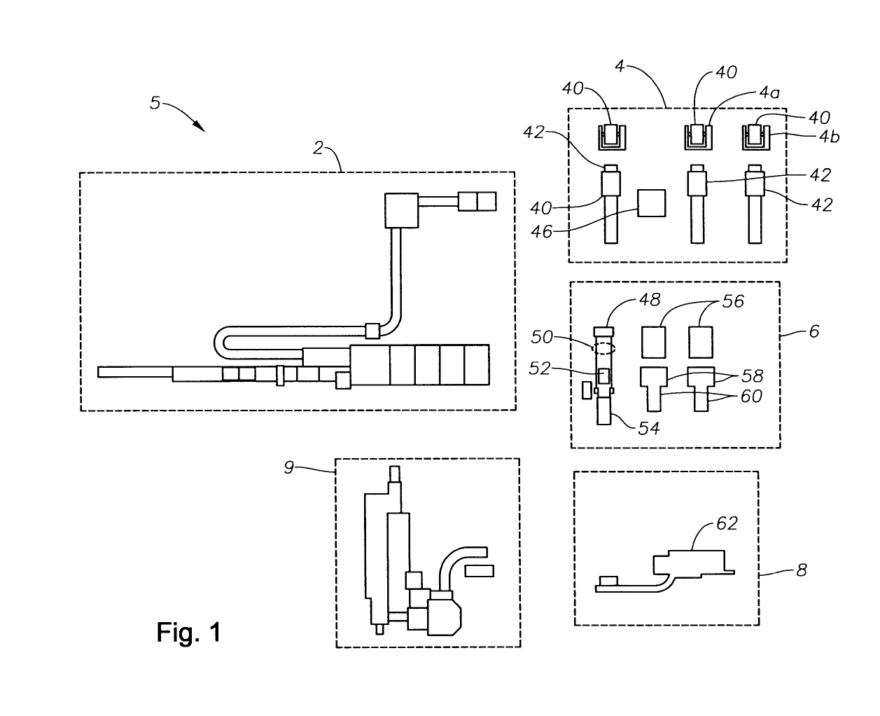

FIG. 1 is an aerial view of floor plan layout 5 for a book production facility according to an exemplary embodiment of the present invention. As shown, floor plan layout 5 includes a initial binding station 2, press station 4, laminate/coating station 6, casing section 8, and completion section 9, all of which will be further described below. Persons ordinarily skilled in the art having the benefit of this disclosure realize that the various stations/machines disclosed herein may be repositioned as necessary to meet production specifications or design/job constraints. Furthermore, in the exemplary embodiments described herein, the machinery consists of an Acoro 3648 (binding station 2) and Diamant EP340L (completion machine 9), both of which are manufactured by Muller Martini of Zofingen, Switzerland; 5000 Plus and 6000 (press 4), manufactured by Xeikon of Belgium; Acculam 33210, manufactured by D&K of Elk Grove Village, Ill. & HP 10012024, manufactured by HP of Haifa, Israel (combined to form laminate/coating station 6); and a Kolobus DA260 (casing machine 8), manufactured by Kolobus of Randen, Deutschland. Accordingly, a detailed description of their construction is not provided herein, as such would be understood by one ordinarily skilled in the art having the benefit of this disclosure. In addition, those same skilled persons realize that other similar machinery may be utilized in practicing the invention as claimed herein.

However, before the production process begins at initial binding station 2, a customer's order must first undergo a preparation process. In certain exemplary embodiments of the system and related methodology, the order consists of a customer's data, such as images and/or text, printed in a preset template designed in such a manner that, after a certain amount of systematic steps, the end result is one or multiple perfect bound book(s), preferably of 18 to 100 pages, in simplex (images on one side of each page) or duplex (images on both sides of each page) form, with a predetermined dimension. In certain embodiments, the dimensions are either L: 8.5×11 inches; or XL: 10×13 inches. Each order is printed with a Banner Sheet (data sheets printed on top of the first page of every order specific to that order). All texts in that order are subsequently printed in a stack beneath the banner sheet. The banner sheet may contain a low-resolution image of the cover of the book, the order number and associated barcode, in-house order line ID and associated barcode, page count, logo/no-logo, product type, case size and similar information. The border of the banner sheet is preferably colored to identify a ship date, where each ship day of the week is one of seven colors. The banner sheet remains with its corresponding order throughout the entirety of the production process.

Further referring to certain exemplary embodiments of the system and related methodology, for convenience in processing, orders are batched (a batch is a number of orders preferably not exceeding 60 orders, grouped by like features such as, for illustrative purposes only, product type, page count range, number of books in an order, or logo/no-logo end sheets) and printed on sheets of uncoated paper, preferably white, 13×19 inch paper. The pages of each book are the first components to be produced. The covers are subsequently printed and manufactured during the exemplary process. The pages are printed in stacks of paper preferably not exceeding 600 sheets off press. The last sheet printed in a batch, and therefore the top sheet, is a batch manifest (last sheet to come off press in the initial printing process that accompanies every batch and contains a list of each order within the coordinating batch). The batch manifest provides information related to the batch, which information may include the batch number, number of orders in the batch, quantity of books in each order, individual order numbers, in-house order line IDs, page count for each order, the scheduled ship date, order number barcodes, and a batch number barcode) intended to facilitate tracking of all orders in that batch.

If a defect occurs within the production process, whether it is operator error or caused by a mechanical issue, all components of the damaged book are separated from the order, and will be collected by a quality control employee. If the entire order fails to meet quality standards, the banner sheet are also discarded. However, if only one book in an order is damaged, the banner sheet moves along the production process with the partial order. The damaged product will be entered into the reprint process, utilizing a computer system, by scanning the barcode that is on the banner sheet. The defects would be considered as fall-out (books unable to continue through production based on the defects that are not in-line with quality standards). Depending on the location of the bin, the quality controller documents the order, defect type, and floor location in which the defect occurred into the computer system.

As will be further described below, in addition to recording defects during the manufacturing process, the present invention allows the scanning of batch sheets at every manufacturing station, thereby permitting enhanced tracking of the progress of individual product production on the floor. Therefore, any order at anytime may be tracked using the present invention.

Further referring to the preparation process, the batch also receives the first cuts on the head (head of the printed image is the location relative to the top horizontal edge of the cover), foot (foot of the printed image is the location relative to the bottom horizontal edge of the cover), and spine (spine of the printed image is the location relative to the left-hand vertical edge of the cover to which all pages are will be anchored.). The remaining two piles of stock paper are placed one on top of the other yielding a single stack, preferably not exceeding a particular limit, such as 1,200 sheets. Because the face (location relative to the right-hand vertical edge of the cover) of the stack was not trimmed, the numerical barcode (reference numbers associated with the order line ID or the batch number) associated with each book's order number remains on the right-hand side of each sheet.

The stack of orders are then transferred to a preparation station. Working from top to bottom of the stack, the direction in which each individual set of pages (sets of pages are also called texts and consist of all the pages that will result in one book.) is rotated, and offset is alternated relative to the rest of the texts in the stack, leaving texts in the same order for processing. Following each individual set of pages is a protective sheet (pages inserted after each book to provide: [1] protection from the surface underneath and [2] an obvious divider between each book) that is at this time removed and stacked separately. The banner sheet is also removed at this time and stacked separately in the exact arrangement that the texts are stacked. Therefore, the top Banner Sheet corresponds to the top text, and the bottom Banner Sheet corresponds to the bottom text, and so on. Accordingly, banner sheets divide orders, while protective sheets divide texts.

After the stack of texts have been prepared as discussed above, there should preferably be three individual piles: protective sheets, banner sheets, and cross-stacked texts. The number of protective sheets should be the same as the number of texts. The number of banner sheets may or may not match either the number of protective sheets or the number of texts; however, if the number of banner sheets is the same as one of the other stacks, it should be the same number as both other piles. If the quantity of protective sheets matches that of the texts, the batch has been correctly prepped and is ready to proceed to binding station 2.

If the quantities differ, however, the cross-stacked texts must be referenced against each order number of the batch manifest to confirm that the correct quantity of each book has been collated and that number of protective sheets has been collected. After the mistake has been corrected, and the stacks have been properly prepared, the protective sheets are discarded, and remaining two stacks are transferred to the binder. Those ordinarily skilled in the art having the benefit of this disclosure realize the foregoing preparation process may be altered as desired.

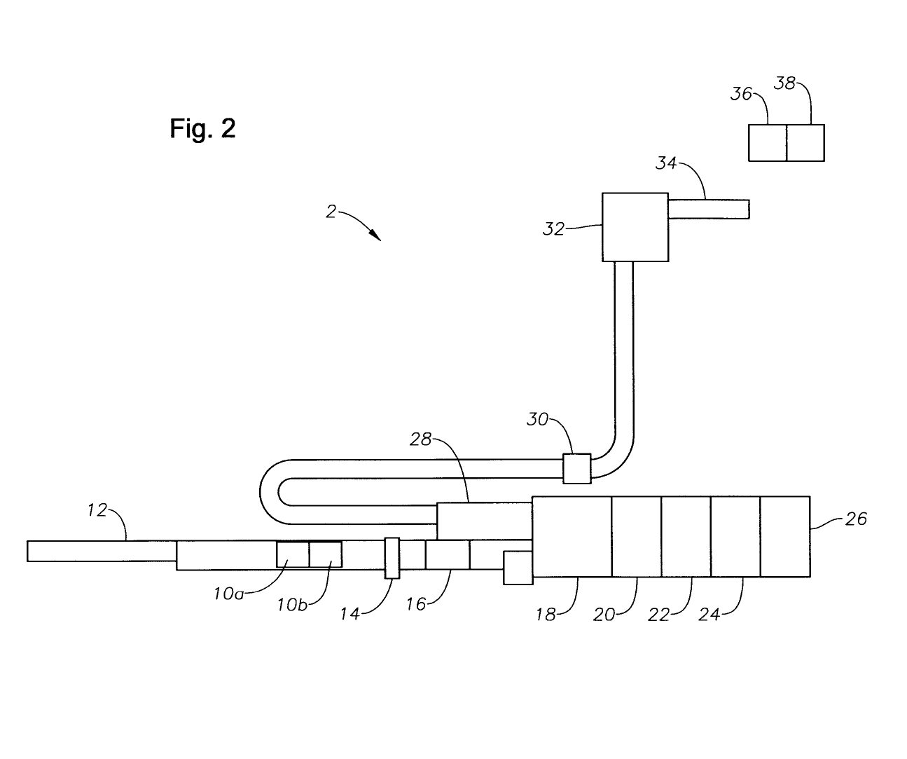

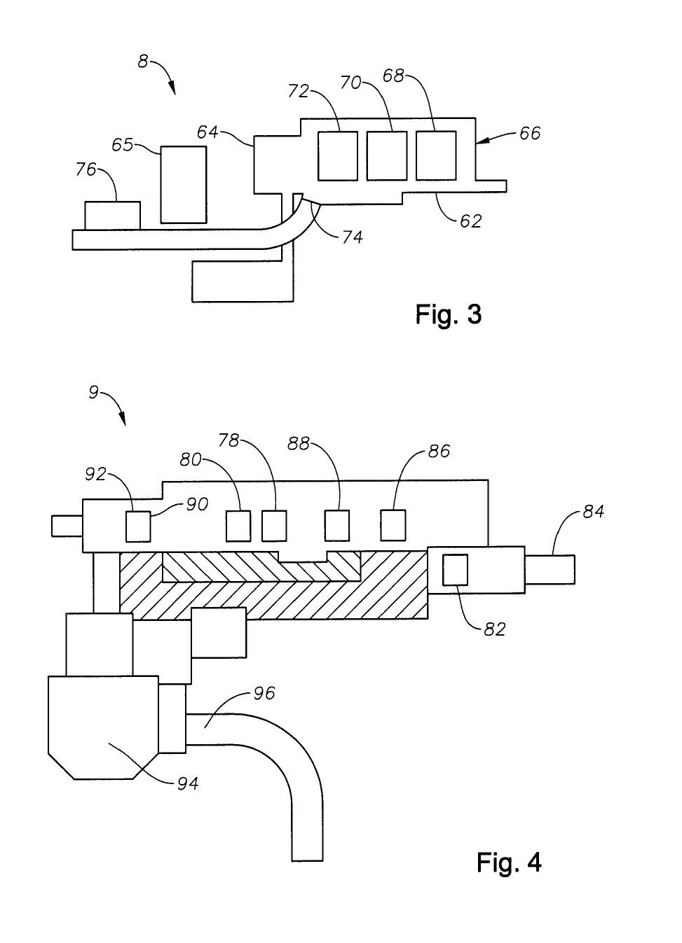

FIG. 2 is an aerial exploded diagrammatical view of initial binding station 2 (also referred to herein as binding machine 2) according to an exemplary embodiment of the present invention. In certain exemplary embodiments, the present invention is an automated, in-line manufacturing solution that reduces much of the labor, error rate and related costs involved in conventional book manufacturing processes. The process begins with a text block, which is a set of pages from an individual book that have been bound with end sheets, but not yet cased into a cover. End sheets are decorative pages that are placed in the front and back of every set of pages, eliminating the chance of glue touching the customers' photos (in embodiments that produce photo books). Each end sheet is a large sheet of paper that has been folded. In certain embodiments, the end sheet is approximately 21 inches and has been folded in half. The outer-most side adheres to the hard-cover case, while the inner pages, which may be patterned and/or ornamental, are bound with the text. End sheets are preferably shorter than the text to allow the barcode to be seen at all times.

To begin the loading process, the batch manifest is scanned to determine if the batch requires logo or no-logo end sheets at the end of the books in that batch. Customers have the option of ordering books with back end sheets that can either depict a logo or not: “logo” and “no-logo,” respectively. In accordance with a particular batch specification, end sheets are loaded into the automatic end sheet feeder 10a,b, which is located at the section of binding section 2 in which any one of the book components is fed in to the machine and entered into production automatically. Thereafter, a corresponding preset program is entered into in-feeder 10 via an appropriate user interface. The program allows customization of the machine settings based on product specifications. Once programmed, the settings are selected and automatically applied to the machine.

The loose texts are inserted one at a time into the text in-feed carriages 12, which are movable dividers or separators that are means by which a component, such as the text, to a book is held while in a machine. Each carriage holds one text at a time with the spine towards the bottom of the in-feed carriages 12, the first page facing up and the barcode on top.

Leaving in-feeders 10a,b & 12, the texts are then transported, via a conveyor belt, through binding station 2 via clamps that rotate the text onto its spine. The clamps apply a slight amount of pressure on the front and back of the text to hold pages to together, while the metal clamps reposition the text so that the spine will be positioned downward. The rotated texts are then automatically fed into an in-line binding process, beginning at adhesive strip applicator 14. Here, binding station 2 (also referred to as binding machine 2) mechanically positions one sheet on the front of the text and one on the back of the text. In certain embodiments, the front end sheet is always no-logo, whereas the rear end sheet varies depending on customer specifications.

Binding machine 2 leaves a separation between each end sheet and the text, allowing for adhesive to be attached to the inside of each end sheet at adhesive strip applicator 14. Here, a small adhesive strip is applied to the inside spine of the end sheets. In this exemplary embodiment, the adhesive strip may be approximately ⅙^{th} of an inch. The ends sheets and text then convey on to pressing wheel 16 where the components are aligned and compressed with the proper amount of force applied evenly along the length of the spine, thus creating a clean, defect-free application of end sheets to the text. Pressing wheel 16 is comprised of two wheels positioned to press the end sheets' adhesive strip such that they adhere to the text.

Further referring to the exemplary embodiment of FIG. 2, the text with end sheets is then conveyed into a transport carriage (not shown), which is a clamp that automatically opens before the texts enter and closes once the texts have completely entered between the two arms of the carriage clamp The clamp holds the text with enough pressure to keep it in exactly the same position as it conveys through the binding process. Then, the text is processed through milling blade 18, where a small strip is cut from the spine, allowing a clean, level surface on which to apply glue. The text and end sheets pass over spine glue roller 20, thus applying glue on the milled spine. Spine glue roller 20 is a cylindrical roller that rotates in a pot of glue positioned so that glue is applied to the text as the spine of the text slides over the top of the roller.

Immediately after the spine glue is applied by spine glue applicator 20, binding machine 2 conveys the text and end sheets through side glue rollers 22, which apply glue on the outside of the end sheets. Side glue rollers 22 comprise cylindrical rollers that are positioned to roll over the outside of the end sheets a short distance from the spine. Immediately after the application of glue to the outside of the end sheets, binding machine 2 then conveys the text and end sheets to crash paper applicator 24, which applies end cap/crash paper to the glued area, thus sealing the loose ends of all pages and, thereby, creating a text block. Crash paper, also referred to as an end cap, is a strip of paper stock cut from a continuous roll of paper to the length of the spine. Crash paper applicator 24 then wraps the crash paper around the spine, covering one inch on the front and back end sheets. Then, the text block is conveyed to nipping plates 26, which apply pressure to press the text block together, thereby adhering the crash paper to the freshly applied spine and side glue.

As binding machine 2 continues to convey the text block, it is dropped onto an out feed track (not shown), which then rotates the text block to position the barcode face-up on the conveyor belt. Binding machine 2 then conveys the text block into bar code reader 28, which reads the barcode on the face of the text. A printer (not shown) prints the barcode on the outside of the front end sheet. In certain embodiments, the printer is an ink jet printer which is a printer that applies the desired image onto the surface underneath an ink jet head. Printing the barcode on the front end sheet ensures the barcode will be present throughout further processing, as the barcode on the face will be trimmed off eventually. The text block then conveys for a short period of time, thus allowing time for the glue to set. In this exemplary embodiment, the conveying is accomplished via a conveyor belt (not shown).

Still referring to the exemplary embodiments represented by FIG. 2, binding machine 2 then conveys the text block through motion sensor 30, which activates a trimmer 32 at the end of the conveyor belt. In trimmer 32,—one or more levers (e.g., metal bars/braces) align the text block while another lever extends down and applies pressure to the text block, holding the text block stationary. The head, foot, and face of the text block are then trimmed, leaving the text block in its final specified size. Also, trimmer 32 trims off the barcode on the text, along with a small portion from the top and bottom, which will be the last text block trim.

Binding machine 2 then ejects the text blocks in the same order they were fed into in-feeders 10a,b & 12. The associated banner sheets are transported to out-feed 34 of trimmer 32. Here, the banner sheet is not feed into the in-feed, but instead is married back to its original order at the out-feed 34. The text blocks from each batch are then matched with their corresponding banner sheets and conveyed to stitcher 36. In certain exemplary embodiments, stitcher 36 is a machine that drives one or more staples through the spine of the text block. Preferably, the staples are three wire staples spaced equidistance from one another. In such case, preferably, one staple is centered and there is a staple on either end near the head and foot of the text block. Although described in relation to staples herein, persons ordinarily skilled in the art having the benefit of this disclosure realize other stitching means, or other numbers of staples, may be utilized.

Stitcher 36 may be adjusted according to the spine width of the text blocks correlating the length of each stitch to the width of the spine. Thus, in certain embodiments, this length is either L or XL. This ensures the stitches are not too short to reach through the entire thickness of the book nor too long that there is excess wire. Each text block is placed on the stitcher platform (not shown) and aligned with the stitcher heads (not shown), as understood in the art. An automatic stapler is then activated to make the stitcher drive staples into the spine end of the text block.

After the text block is stitched, the stitched end is placed into smasher 38. Smasher 38 is a machine that applies pressure to the front and back of a text block along the spine after the staples have been inserted. Smasher 38 serves to make the staples smooth and consistent on the surface of the text block. Electronic sensors embodied within smasher 38 read the presence of the text block, making the metal block on either side of the text block crush the spine under a select pressure for a predetermined time. Smasher 38 then releases the text block, after which it is matched with its correct banner sheet by matching order numbers, and the banner sheet is placed on top of the text block. All text blocks in the batch are stitched, smashed, and stacked in this manner.

Hereafter, in reference to the exemplary embodiment of FIG. 1, the text blocks are then transported to digital web press 4 for further processing. In certain embodiments, a digital web press 4 may be used to produce photo wraps and dust jackets. A photo wrap is a sheet of paper that wraps around a chipboard in order to later become a hard-cover case. A dust jacket is a detachable decorative sheet of paper that is creased and folded around the hard-cover case that serves as the outer-most layer of protection for the book. Although photo books are discussed in this description, ordinarily skilled persons having the benefit of this disclosure realize the present invention can be utilized to produce a variety of books. Moreover, those same skilled persons realize that printers, other than the disclosed digital web press, may be utilized herein.

In certain exemplary embodiments, digital web press 4 prints simplex either 1-up or 2-up depending on the dimensions of the book-product types, and they are printed in the same order the text blocks were printed. Any number followed by “up” refers to the number of items printed simultaneously on one sheet of paper. For example, “2-up” means that there are 2 of one page of the same type of book printed on one sheet of paper.

The batch number for a particular order is entered into digital web press 4, and, subsequently, the wraps and jackets for all text blocks in that batch are printed. Roll stock 40 (i.e., paper stock to be printed that comes rolled around a circular center rod as shown) is fed into print chamber 42 and conveys through a series of rollers (not shown) in printing chamber 42. Here, digital web press 4 prints the images on the stock of the jackets and wraps. In addition, digital web press includes a barcode scanner which applies the respective barcode to the underside of the wraps and jackets based upon the respective batch numbers. These codes will be used to coordinate the casing process described below. Although the stock used for the wraps and jackets may be the same, they are distinguished by different finish coatings and dimensions.

Also, in certain exemplary embodiments, digital web press 4 includes a slitter 44 which attaches to print chamber 42 near pile feeder 46. Pile feeder 46 is the output tray of digital web press 4, where the wraps and jackets are stacked after printing and slitting has occurred. Slitter 44 cuts the 2-up wrap and jacket sets to separate the two components as they come off the press. In certain exemplary embodiments, a second and third digital web press 4a,4b are positioned beside digital web press 4 which has no slitter. Here, digital web presses 4a,b run 1-up, and digital web press 4, with slitter 44, runs 2-up. Two presses allow production to move faster, reduce turn time, decrease standard service level agreement (“SLA”) rates, and improve workflow efficiency. Using digital web presses 4a,b, the wraps and jackets must be manually cut since there is no slitter 44 present. The wraps and jackets are then stacked with the batch to which they belong. Those ordinarily skilled in the art having the benefit of this disclosure realize that a variety of digital web presses may be utilized as desired.

Further referring to the exemplary embodiment of FIG. 1, the wraps and jackets are then transported to laminating/UV coating machine 6. UV coating is an ultraviolet light-reactive clear plastic coating that solidifies with UV radiation that, in turn, protects the underlying material from fading and damage. At this station, UV coating is rolled onto the dust jackets prior to their final trim. To do this, the jackets are stacked in product in-feed 48 face up, which then inserts them one at a time onto a conveyor that carries then under UV coating roller 50. The jackets are then conveyed under curing lamps 52, which are ultraviolet lights that radiate the light necessary to solidify the coating, and ejected out onto product out-feed stacker 54.

Also, at laminating/UV coating machine 6, the wraps are stacked on pile feeder 56 face up in the order they came off digital web press 4, and fed one at a time onto a conveyor that carries them under laminator rollers 58 (not shown), which are rollers that hold the plastic laminate before it is applied to the stock. Laminate is a plastic coating applied to the wraps before they are transformed into hard-bound cases. Thereafter, a slitter 58 cuts each wrap, which are then conveyed into a jogger (not shown) that vibrates the wraps along an angled lipped table, thereby aligning them in a stack. The stack is then conveyed out onto out-feed tray 60. Certain exemplary embodiments also includes a second laminator, which reduces turn time, decreases standard SLA rates, and improves workflow efficiency. Persons ordinarily skilled in the art having the benefit of this disclosure realize that any number of UV/laminate machines may be utilized as desired.

After the coating application is complete, the photo wraps and dust jackets are cut to final size, relative to the particular size of the books. Thereafter, the text blocks, wraps, and dust jackets are all transferred to casing section 8.

In certain exemplary embodiments, batches are separated by page count ranges. For example, batches may be separated by page count ranges of 18-29, 30-39, 40-49, 50-64, 65-75, 76-89, and 90-100. In addition, Spine sizes may be 7 mm, 9 mm, and 11 mm widths, which are determined by page count, and come in both L and XL lengths; 7 mm spines, designated “A”, bind books containing 18-64 pages; 9 mm spines, designated “B”, bind books containing 65-89 pages; 11 mm spines, designated “C”, bind books containing 90-100 pages. However, as would be understood by one ordinarily skilled in the art having the benefit of this disclosure, other page count ranges and spines sizes can be tailored as desired. Also, in this exemplary embodiment, the barcode on the underside of the dust jacket, and the barcode on the underside of the photo wrap are both printed with an A, B, or C, designating the spine size needed for each batch, which coordinates with the same numerical barcode on the text block. As previously described, these bar codes were printed using digital web press 4.

Referring to FIGS. 1 & 3, at casing section 8, the creasing machine is adjusted based relative to the indicated spine size, and inserts the jackets one at a time into the case maker 62 at in-feed 64. Hard-Cover cases are created by case maker 62 in an automatic process by fastening the photo wrap around three pieces of chipboard (not shown), which are inserted at in-feed 66. Chipboard is a type of cardboard used to give the hard-cover book its rigidity. After the chipboard is insert, it is conveyed to a cutter 68 and cut into the three components of a hard cover: the front cover, the back cover, and the spine (in this embodiment, front and back covers can be of a predetermined sized (such as for example, either L or XL, whereas the spine has a width of A, B, or C and a length of L or XL).

The case maker 62 is then set according to the indicated spine size. Chipboard, correlated to the correct case size, is loaded in to in-feed 66 at the rear of the case maker 62. The laminated photo wraps are inserted into the in-feed 64 at the front of the case maker 62. However, before they are loaded, the wraps are trimmed on all four edges using corner cutter 65 to remove excess paper and control the exact measurements prior to creating the case, so that the wrap can be properly wrapped around the chipboard. As previously mentioned, case maker 62, through an entire automated process, cuts the chip board into the dimensions of the front cover, back cover and spine (such as may be indicated by the A, B, or C, and L and XL settings). A glue applicator 70 then applies glue to the imageless side of the wrap. Case maker 62 then places the chipboard at appropriate preset locations on the glue on the wrap, and the edge of the photo wrap is folded around the edges by wrap mechanism 72, overlapping about one inch onto the reverse side of the chipboard.

After complete photo wraps, or cases, convey out of the case maker 62 at exit 74, they are may be inspected for quality. Thereafter, the spine is broken. “Breaking the spine” is the process of creasing the wrap on either side of the spine of the chipboard in order to give the hard cover case its preliminary shape. To do so, the case is straddled over a vertical metal frame of spine breaker 76 and presses on the case, bending the wrap in the gap between the spine and either cover.

Thereafter, text blocks, cases, and dust jackets are transferred to a matching area located adjacent completion machine 9. Here, all three components are reconciled based on the order number which is the numerical barcode found on all three components. Each of the three components of every order is stacked in separate piles. The first order number in the pile of text blocks corresponds to the first order number of the pile of jackets and the first number in the pile of cases. The text blocks are stacked on top of one another. Wraps stand on edge in correspondence with the texts and cases, and they are placed from the outside working inward. Jackets are folded and stacked next to the texts and cases. All components in the batch are stacked in the same order, so that each piece goes into the next machine in the same order.

Referring to the exemplary embodiments of FIGS. 1 & 4, thereafter, the matched text blocks, cases, and dust jackets are transferred to completion section 9 (also referred to as completion machine 9) in order to compile the completed books. The completion machine 9 is adjusted based on the spine size (such as, for example, A, B, or C). The cases are loaded into completion machine 9 with the barcode facing down at case in-feed 78. Completion machine 9 then scans the barcode, via scanner 80, on each case and compares it against the barcode on each text block, which are scanned using scanner 82, before the components are bound to verify they belong to the same book. In the alternative, a preliminary verification of the text blocks and cases can be performed to ensure they match before loading them into in-feeds 78,84. A hand-held scanner may be utilized to perform this check.

The text blocks are fed onto a conveyor belt (in-feed 84) one at a time with the ink-jetted barcode facing up on the end sheet. After being scanned at scanner 82, the text blocks convey onto headband applicator 86. Headbands are ornamental fabric at the head and foot of a book between the spine of the text block and the spine of the cover that projects slightly beyond the head and foot of the text block, yet not exceeding the length of the case. Applicator 86 applies the headbands on the top and the bottom of the spine. The text blocks are then conveyed through a set of rollers that apply glue to the outer sides of both front and back end sheets (i.e., glue applicator 90). The text blocks are then inserted into the corresponding case at insertion mechanism 92. The cased texts blocks are then conveyed to a smasher 94, where pressure is applied to both front and back of the book to form the spine and secure the glue. Finally, completed books are stacked on a conveyor belt as they exit the completion machine 9 via book out-feed 96.

As the completed books exit book out-feed 96, the books are stacked one on top of each other with their correlating banner sheet. Books are quality checked and then proceed to the shipping area where jackets are matched, and manually applied to the books. The books then receive their final quality control check, verifying all components against the order number, numerical bar code, and a high resolution PDF.

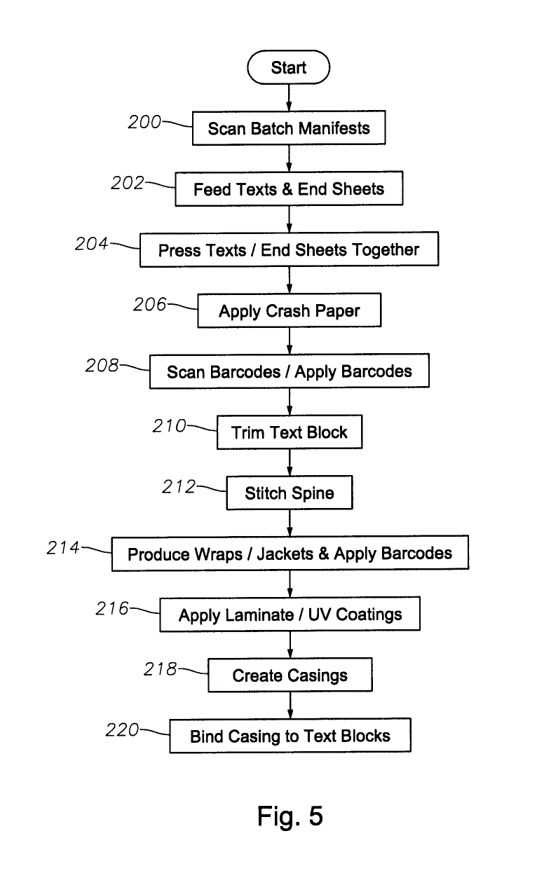

FIG. 5 illustrates a process flow chart according to an exemplary methodology of the present invention. For the sake of simplicity, the following process does not reiterate each step of the foregoing description. At step 200, the batch manifest is scanned to determine the batch specifications and machine presets. At step 202, the text and front/back end sheets are feed into initial binding machine 2 to begin the automated process of the present invention. At step 204, the adhesive strip is applied and the text and front/back ends are pressed at wheel 16. At step 206, the spine is glued and the crash paper is applied by applicator 24. At step 208, the bar code on the face of the text is scanned using reader 28, and printed on the outside of the front end sheet. At step 210, the text block is trimmed to its final size with the barcode printed on the front end sheet remaining visible. At step 212, the spine of the text block is stitched by stitcher 36. At step 214, the wraps and jackets are produced and the barcodes are applied to the jackets and wraps. At step 216, the laminate and UV coatings are applied at coating station 6. At step 218, the hard cover cases are created using casing machine 8. Finally, at step 220, the text block and casing barcodes are matched, and the casing is bound to the text block.

Utilizing the present invention, book production efficiency is greatly increased. In conventional processes using more manual production operations, roughly 2400 books can be produced in a 12 hour period. However, utilizing the system and methods of the present invention, roughly 5000 books can be produced in 1 hour. Thus, the present invention doubles, in 1 hour, the output that it took conventional methods to produce in a day.

Although various embodiments and methodologies have been shown and described, the invention is not limited to such embodiments and methodologies, and will be understood to include all modifications and variations as would be apparent to one skilled in the art. For example, the various book components described herein could be transferred between machines manually or by some automated means such as, for example, a conveyor belt. Therefore, it should be understood that the invention is not intended to be limited to the particular forms disclosed. Rather, the intention is to cover all modifications, equivalents and alternatives falling within the spirit and scope of the invention as defined by the appended claims.

What we claim is:

1. An automated book production process comprising the steps of:
(a) feeding end sheets and a text into a binding machine, the text comprising a plurality of pages;
(b) positioning an end sheet on a front and back of the text, thereby resulting in a front end sheet and a back end sheet;
(c) pressing the front and back end sheets into the text;
(d) applying crash paper to a spine of the text and a portion of the front and back end sheets, thus creating a text block;
(e) conveying the text block to a mechanism adapted to press the text block together;
(f) pressing the text block;
(g) conveying the text block for a sufficient amount of time to allow adhesive on the text block to dry;
(h) conveying the text block to a trimmer;
(i) trimming the text block;
(j) inserting at least one stitch through the spine using a stitching mechanism;
(k) producing a casing for the text block; and
(l) inserting the text block into the casing, thereby forming a book.

2. An automated book production process as defined in claim 1, wherein step (b) further comprises the step of:
positioning the end sheets such that a separation is present between the end sheets and the text; and
applying adhesive along the separations.

3. An automated book production process as defined in claim 1, wherein step (b) further comprises the step of positioning the front end sheet such that a barcode on a face of the text is visible.

4. An automated book production process as defined in claim 3, wherein step (f) further comprises the steps of:
rotating the text block such that the barcode is facing up;
scanning the barcode using a barcode reader; and
printing the barcode on the front end sheet using a printer located adjacent the barcode reader.

5. An automated book production process as defined in claim 1, wherein step (i) further comprises the step of activating the trimmer using a motion sensor, wherein the motion sensor is activated upon sensing movement of the text block.

6. An automated book production process as defined in claim 1, wherein step (j) further comprises the steps of:
placing the stitched spine into a pressing mechanism;
sensing a presence of the stitched spine; and
applying pressure to the stitched spine such that the at least one stitch does not protrude out beyond a surface of the text block.

7. An automated book production process as defined in claim 1, wherein step (k) further comprises the steps of:
producing a wrap;
inserting the wrap into a casing machine;
inserting a chipboard into the casing machine;
cutting the chipboard to predetermined dimensions;
applying the chipboard to a corresponding wrap, thus forming a casing; and
conveying the casings out of the casing machine.

8. An automated book production process as defined in claim 1, wherein step (1) further comprises the steps of:
feeding the casing and text block into a completion machine;
applying a headband to the text block;
reading barcodes on the casing and text block;
verifying that barcodes of the casing and text block are matches;
inserting the text block into the corresponding casing, thus forming the book; and
conveying the book out of the completion machine.

9. An automated book production process as defined in claim 1, further comprising the step of utilizing the barcode to track at least one of a text, wrap, jacket, casing, or book throughout the production process.

10. An automated book production process as defined in claim 1, wherein the book is a hard cover photo book.

11. An automated book production process comprising the steps of:
(a) feeding end sheets and a text into a binding machine using a conveying mechanism, the text comprising a plurality of pages;
(b) applying an end sheet on a front and back of the text, thereby resulting in a front end sheet and a back end sheet;
(c) conveying the text into a crash paper applicator, wherein crash paper is applied to a spine of the text and a portion of the front and back end sheets, thus creating a text block;
(d) conveying the text block to a barcode reader, wherein a barcode of the text block is read and, thereafter, printed on the text block;
(e) trimming the text block;
(f) binding a spine of the text block; and
(g) inserting the text block into a casing, thereby forming a book,
wherein steps (a)-(e) are performed without removing the text or text block from the binding machine.

12. An automated book production process as defined in claim 11, wherein step (f) further comprises the step of inserting at least one staple into the spine.

13. An automated book production process as defined in claim 11, wherein step (b) further comprises the step of positioning the front end sheet such that a barcode on a face of the text is visible.

14. An automated book production process as defined in claim 13, further comprising the steps of:
rotating the text block such that the barcode is facing up;
scanning the barcode; and
printing the barcode on the front end sheet.

15. An automated book production process as defined in claim 11, wherein step (e) further comprises the step of activating the trimmer using a motion sensor.

16. An automated book production process as defined in claim 12, further comprising the steps of:
placing the stapled spine into a pressing mechanism;
sensing a presence of the stapled spine; and
applying pressure to the stapled spine such that the at least one staple does not protrude out beyond a surface of the text block.

17. An automated book production process as defined in claim 11, wherein step (g) further comprises the steps of:
producing a wrap;
inserting the wrap into a casing machine;
inserting a chipboard into the casing machine;
cutting the chipboard to predetermined dimensions;
applying the chipboard to a corresponding wrap, thus forming a casing; and
conveying the casing out of the casing machine.

18. An automated book production process as defined in claim 11, wherein step (g) further comprises the steps of:
feeding the casing and text block into a completion machine;
applying a headband to the text block;
reading barcodes on the casing and text block;
verifying the barcodes of the casing and text block are matches;
inserting the text block into the corresponding casing, thus forming the book; and
conveying the book out of the completion machine.

19. An automated book production process as defined in claim 11, further comprising the step of utilizing the barcode to track at least one of the text, wrap, jacket, casing, or book throughout the production process.

20. An automated book production process as defined in claim 11, wherein the book is a photo book.

21. An automated system for book production, the system comprising:
a mechanism adapted to receive end sheets and a text, the text comprising a plurality of pages;
a mechanism adapted to position an end sheet on a front and back of the text, thereby resulting in a front end sheet and a back end sheet;
a mechanism adapted to apply crash paper to a spine of the text and a portion of the front and back end sheets, thus creating a text block;
a conveyor belt to convey the text block to a pressing mechanism, wherein the text block is pressed, the conveyor belt continuing to convey the text block for a sufficient amount of time to allow adhesive on the text block to dry;
a trimmer adapted to trim the text block;
a stitching mechanism adapted to insert at least one stitch through the spine;
a casing mechanism adapted to produce a casing for the text block; and
a completion mechanism adapted to insert the text block into the casing, thereby forming a book.

22. An automated system as defined in claim 21, further comprising a mechanism adapted to position the front end sheet such that a barcode on a face of the text is visible.

23. An automated system as defined in claim 22, further comprising:
a mechanism adapted to rotate the text block such that a barcode of the text block is facing up;
a barcode scanner adapted to scan the barcode; and
a printer adapted to print the barcode on the front end sheet.

24. An automated system as defined in claim 21, further comprising a motion sensor adapted to activate the trimmer upon sensing movement of the text block.

25. An automated system as defined in claim 21, further comprising a pressing mechanism adapted to sense a presence of the stitched spine and, in response, apply pressure to the stitched spine such that the at least one stitch does not protrude out beyond a surface of the text block.

26. An automated system as defined in claim 21, wherein the casing mechanism comprises:
a mechanism adapted to receive the casing;
a mechanism adapted to receive a wrap;
a cutter adapted to cut a chipboard to predetermined dimensions;
a mechanism adapted to apply the chipboard to a corresponding wrap, thus forming a casing; and
a mechanism adapted to convey the casings out of the casing mechanism.

27. An automated system as defined in claim 21, wherein the completion mechanism comprises:
a mechanism adapted to receive the casing and text block;
a mechanism adapted to apply a headband to the text block;
a scanner adapted to read barcodes on the casing and text block;
a mechanism adapted to verify that barcodes of the casing and text block are matches;
a mechanism adapted to insert the text block into the corresponding casing, thus forming the book; and
a mechanism adapted to convey the book out of the completion mechanism.

28. An automated system as defined in claim 21, further comprising a mechanism to utilize barcodes to track at least one of a text, wrap, jacket, casing, or book throughout the production process.

29. An automated system as defined in claim 21, wherein the book is a hard cover photo book.

30. An automated system for book production, the system comprising:
a binding machine comprising:
a mechanism adapted to receive end sheets and a text, the text comprising a plurality of pages;
a mechanism adapted to apply an end sheet on a front and back of the text, thereby resulting in a front end sheet and a back end sheet;
a mechanism adapted to convey the text into a crash paper applicator, wherein crash paper is applied to a spine of the text and a portion of the front and back end sheets, thus creating a text block;
a mechanism adapted to convey the text block to a barcode reader, wherein a barcode of the text block is read and, thereafter, printed on the text block; and
a trimmer adapted to trim the text block, wherein the text and text block are conveyed through the binding machine without the need to remove the text or text block from the binding machine, and
a completion machine adapted to insert the text block into a casing, thereby forming a book.

31. An automated system as defined in claim 30, further comprising a stitching mechanism adapted to insert at least one staple into a spine of the text block.

32. An automated system as defined in claim 30, wherein the binding machine further comprises:
a mechanism adapted to rotate the text block such that the barcode is facing up;
a scanner adapted to scan the barcode; and
a printer adapted to print the barcode on the front end sheet.

33. An automated system as defined in claim 30, wherein the binding machine further comprises a motion sensor adapted to activate the trimmer.

34. An automated system as defined in claim 31, further comprising:
a mechanism adapted to sense a presence of the stapled spine; and
a mechanism adapted to apply pressure to the stapled spine such that the staples do not protrude out beyond a surface of the text block.

35. An automated system as defined in claim 30, further comprising a casing machine, the casing machine comprising:
a mechanism adapted to receive a wrap;
a cutter to cut a chipboard to predetermined dimensions;
a mechanism adapted to apply the chipboard to a corresponding wrap, thus forming the casing; and
a mechanism adapted to convey the casing out of the casing machine.

36. An automated system as defined in claim 30, wherein the completion machine comprises:
a mechanism adapted to receive the casing and text block;
a mechanism adapted to apply a headband to the text block;
a mechanism adapted to read barcodes on the casing and text block;
a mechanism adapted to verify that barcodes of the casing and text block are matches;
a mechanism adapted to insert the text block into the corresponding casing, thus forming the book; and
a mechanism adapted to convey the book out of the completion machine.

37. An automated system as defined in claim 30, further comprising a mechanism adapted to utilize barcodes to track at least one of the text, wrap, jacket, casing, or book throughout the production process.

38. An automated system as defined in claim 30, wherein the book is a photo book.
